(19) United States
(12) Patent Application Publication
(10) Pub. No.: US 2018/0190152 A1
(43) Pub. Date: Jul. 5, 2018

(54) BUTTON HAVING VARIABLE BRAILLE MODULES

(71) Applicant: Insik SEO, Daejeon (KR)

(72) Inventor: Insik SEO, Daejeon (KR)

(21) Appl. No.: 15/741,089

(22) PCT Filed: Nov. 29, 2016
(86) PCT No.: PCT/KR2016/013850

§ 371 Date: Dec. 29, 2017

(30) Foreign Application Priority Data
May 2, 2016 (KR) 10-2016-0053891

(51) Int. Cl. G09B 21/00; G06F 3/02

(52) U.S. Cl. CPC G09B 21/004; G06F 3/02

(57) ABSTRACT

Disclosed is a button having variable Braille modules. The button is structured such that a plurality of protrusions is moved up and down to display information such as Braille words, figures, and images so that visually impaired people can read the information through tactile sensation of their fingers.

### TECHNICAL FIELD

The present invention relates to a button having variable Braille modules. More particularly, the present invention relates to a button having variable Braille modules, in which a plurality of protrusions is moved up and down to display information such as Braille words, figures, or images so that the visually impaired can obtain information through tactile sensation.

### BACKGROUND

Braille is a character symbol system that gives meaning to various dot patterns so that people can read and write through the tactile sensation. In general, 2*2, 3*2, or 4*2 dot patterns are widely used for a Braille character system, and the character system is constructed by varying the number and arrangement of dots.

Meanwhile, with the development of information and communication industry, the use of information and communication devices such as computers, mobile phones, personal digital assistants (PDAs), and portable multimedia players (PMPs) has become common nowadays. However, since physically challenged people, for example, visually impaired people cannot easily use the information and communication devices, the visually impaired feel alienated in the utilization of information and communication devices, which results in a digital divide. Therefore, it is required to eliminate economic and social inequality with regard to the access to information and communication technologies.

In order to alleviate the digital divide by helping the visually impaired to use information and communication devices so that the visually impaired have improved access to information, various software and Braille display devices have been developed. A Braille display device is a tactile device in which one Braille character is represented by one cell comprising a plurality of pins and the visually impaired can identify the Braille characters through skin stimulation such as pressure, vibration, and stimulation to the skin.

Conventional Braille modules are categorized according to the type of actuator. Representative actuator types include a solenoid type, a piezoelectric type, and a polymer dielectric type.

The solenoid type operates in a manner that a magnetic field is generated in accordance with an electrical signal input to a coil and a plunger provided inside the coil moves due to the force generated by the magnetic field, thereby outputting a Braille character.

The piezoelectric type operates in a manner in which the length of a piezoelectric element changes in accordance with an electrical signal applied the piezoelectric element and a Braille character is read by detecting the change in the length of the piezoelectric element.

The polymer dielectric type has a structure in which electrodes are provided on respective surfaces of a polymer dielectric material having a high dielectric constant, such as silicone or urethane. The polymer dielectric type operates based on the principle that a voltage is applied between the electrodes, so that the polymer dielectric material is compressed in the thickness direction and expanded in the lateral direction due to the attraction force between the electrodes.

However, the solenoid type has a problem that it is difficult to increase an integration degree of solenoid elements serving as Braille character outputting elements.

Meanwhile, the piezoelectric type has a problem that it is difficult to control an application voltage because an electrical potential applied between respective terminals of the piezoelectric element to cause the change in the length of the piezoelectric element having a long length is considerably high. The polymer dielectric type has a problem that it is necessarily required to supply a high voltage of 1 to 2 kV to cause the desired change in the volume of a predetermined polymer material. That is, there is a problem that it is difficult to miniaturize a driver unit of a Braille module and a controller for controlling the driver unit and it is difficult to provide a Braille module with a high response speed.

Korean Patent No. 10-0734731 discloses “Braille Outputting Module and a Display Device with the Same”.

The Braille outputting module includes a housing, a guide, and a piezoelectric actuator. The shaft of the piezoelectric actuator is guided by the guide and is driven outside and retreated into the housing through an opening of the housing, thereby displaying a Braille character.

### DOCUMENTS OF RELATED ART

### Patent Document

(Patent Document 1) Korean Patent No. 10-0734731 (registered as of Jun. 27, 2007)

### DISCLOSURE

### Technical Problem

Accordingly, the present invention has been made to solve the problems described above, and an objective of the present invention is to provide a button having variable Braille modules in which the button has an advantage of reducing the number of parts controlled to display information, whereby the Braille modules have a simple structure and can be conveniently controlled.

The objective of the present invention is not limited to the one described above, and other unmentioned objectives can be clearly understood from the following description by those ordinarily skilled in the art.

### Technical Solution

In order to accomplish the objective of the present invention, according to one embodiment of the present invention, there is provided a button having variable Braille modules, the button including: an information display unit 1000 including a plurality of variable Braille modules 1100 to display information, the variable Braille modules 1100 including a plurality of upper protrusions 210 arranged in rows and columns; and a button 2000 configured to input a command corresponding to a content of the information displayed on the information display unit 1000 when the button 2000 is pressed or touched.

In addition, each of the variable Braille modules 1100 may include: a display unit 100 provided with a plurality of through holes 101 arranged in a predetermined pattern; upper blocks 200 provided under the respective through holes 101 and configured to move up and down such that the upper protrusions 210 moves through the respective through holes 101 to selectively protrude from upper ends of the through holes 101 in accordance with upward and downward movement of the upper blocks 200; an upper support block 300 configured to lock the upper block 200; lower blocks 400 provided under the respective upper blocks 200 and configured to move up and down, the lower blocks 400 pushing up the respective upper blocks 400 when moving up; elastic units 500 provided under the respective lower blocks 400 to apply pushing-up force to the lower blocks 400; and a lower adjustment unit 600 configured to restrict upward movement of the lower blocks 400 to a predetermined height limit; wherein the upper support block 300 locks the upper blocks 200 in a row or column unit of the variable Braille modules 1100, and the lower adjustment unit 600 restricts upward movement of the lower blocks 400 in a row or column unit of the variable Braille modules 1100.

In addition, each of the upper blocks 200 may include: a movement shaft portion 220 extending downward from a lower end of the upper protrusion 210 and having a pillar shape corresponding to that of the through hole 101 and having a horizontal cross-sectional area smaller than that of the through hole 101; an upper-end upward movement stopper 230 extending from a lower end of the movement shaft portion 220 and having a pillar shape having a horizontal cross-sectional area larger than that of the through hole 101; an upper pillar portion 240 extending from a lower end of the upper-end upward movement stopper 230 and having a horizontal cross-sectional area smaller than that of the upper-end upward movement stopper 230; and an engagement portion 250 being recessed or protruding in a horizontal direction from a side surface of the upper pillar portion 240.

In addition, each of the upper blocks 200 may further include an upper-end downward movement stopper 260 extending from a lower end of the upper pillar portion 240 and having a pillar shape having a horizontal cross-sectional area larger than that of the upper pillar portion 240.

In addition, the upper support block 300 may be assembled with the upper pillar portion 240 in a manner of horizontally moving with respect to a center of the upper pillar portion 240, and the upper support block 300 may be provided with a movement slot 301 through which the upper pillar portion 240 moves.

In addition, each of the lower blocks 400 may include: a lower-end upward movement stopper 410; a lower pillar portion 420 extending downward from a lower end of the lower-end upward movement stopper 410 and having a pillar shape having a horizontal cross-sectional area smaller than that of the lower-end upward movement stopper 410; a lower-end downward movement stopper 430 extending downward from a lower end of the lower pillar portion 420 having a pillar shape having a horizontal cross-sectional area larger than that of the lower pillar portion 420; and a first inclined portion 440 provided at an upper surface of the lower-end downward movement stopper 430 and configured as an inclined surface, wherein the lower adjustment unit 600 is assembled with the lower pillar portion 420 in a manner of horizontally moving with respect to a center of the lower pillar portion 420 and is provided with a second inclined portion 610 having a shape corresponding to that of the first inclined portion 440, and wherein the first inclined portion 440 and the second inclined portion 610 are in tight contact with each other while facing each other, thereby causing the lower block 400 to move down when the lower adjustment unit 600 is horizontally moved.

In addition, a lower end of the lower-end downward movement stopper 430 may be provided with a recess-shaped or protrusion-shaped elastic coupling portion 431 to be engaged with the elastic unit 500.

In addition, the button having variable Braille module may further include a housing 700 in which the upper block 200 and the lower block 400 are completely accommodated and the upper support block 300 and the lower adjustment unit 600 are partially accommodated such that the upper support block 300 and the lower adjustment unit 600 are partially exposed outside the housing 700, wherein the housing 700 is provided with an upper guide slot 710 through which the upper support block 300 horizontally moves and which maintains a horizontal height of the upper support block 300 and a lower guide slot 720 through which the lower adjustment unit 600 horizontally moves and which maintains a horizontal height of the lower adjustment unit 600.

In addition, the button 2000 may be spaced from the variable Braille modules 1100 by a predetermined distance and may be configured to input a command when the button 2000 is touched or pressed.

In addition, the button 2000 may be integrated with the variable Braille modules 1100, so that the button 2000 inputs a command when the variable Braille modules 1100 are touched or pressed.

### Advantageous Effects

According to the button having variable Braille modules according to one embodiment of the present invention, with the use of the button provided with the variable Braille modules, the visually impaired can use equipment, such as a KIOSK (for example, an automated teller machine (ATM)), that performs a user-selective function according to a user input.

In addition, it is possible to display information such as Braille words, figures, or images by operating the lower adjustment unit and the upper support block row by row or column by column of the Braille modules. Therefore, the number of parts that are controlled to display information through up and down movement of the protrusions is minimized (for example, n+m parts are operated according to the present invention while n*m parts are operated according to conventional arts). Therefore, the control for displaying information in Braille becomes simpler and more convenient.

In addition, since the movement shaft portion, the upward movement stopper, the upper pillar portion, and the engagement portion are structured such that the upper block is moved up and down in a state of being assembled with the upper support block, the upper block has a structure that can be easily processed.

In addition, since the upper block is provided with the downward movement stopper, it is possible to prevent the upward movement stopper from being damaged. Furthermore, even when the upward movement stopper is damaged, it is possible to prevent the upper block from excessively protruding from the upper end of the through hole.

In addition, since the upper support block is provided with the movement slot, the upper support block can lock the upper block while having a simple structure.

In addition, since the lower-end upward movement stopper, the lower pillar portion, the lower-end downward movement stopper, and the first inclined portion are structured such that the lower block is moved up and down in a state of being assembled with the lower adjustment unit, the lower block has a structure that can be easily processed.

In addition, since the elastic coupling portion provided in the lower-end downward movement stopper has a recess shape or a protrusion shape, it can be formed through a simple process.

In addition, since the housing is provided with the upper guide slot and the lower guide slot, the structure that can guide the horizontal movement of the upper support block and the lower adjustment unit and the vertical movement of the upper block and the lower block can be easily processed.

### BRIEF DESCRIPTION OF THE DRAWINGS

FIG. 1 is a plan view illustrating the concept of a button having variable Braille modules according to one embodiment of the present invention;

FIG. 2 is a plan view illustrating the concept of a button having variable Braille modules according to another embodiment of the present invention;

FIG. 3 is a perspective view illustrating an operational relationship among parts of the button having variable Braille modules according to one embodiment of the present invention;

FIG. 4 is an exploded perspective view of FIG. 1;

FIG. 5 is an exemplary view illustrating an example of an upper block of the button having variable Braille modules according to one embodiment of the present invention;

FIG. 6 is an exemplary view illustrating an example of an upper block and an upper support block of the button having variable Braille modules according to one embodiment of the present invention;

FIG. 7 is an exemplary view illustrating another example of the upper block and the upper support block of the button having variable Braille modules according to one embodiment of the present invention;

FIG. 8 is an exemplary view illustrating the upper block of FIG. 1;

FIGS. 9 to 11 are cross-sectional views illustrating an operational relationship between the upper block and the upper support block of FIG. 1;

FIGS. 12 and 13 are perspective views illustrating a lower block of FIG. 1;

FIG. 14 is a perspective view illustrating a lower adjustment unit of FIG. 1;

FIGS. 15 to 17 are plan views illustrating an operational relationship of FIG. 1; and

FIG. 18 is a partially cut-away exploded perspective view illustrating that the button having variable Braille modules according to one embodiment of the present invention includes a housing.

### BEST MODE

The present invention may be variously modified and may have various embodiments, so specific embodiments of the present invention are illustrated in the accompanying drawings and will be described in detail with reference to the accompanying drawings. However, those skilled in the art would appreciate that the present invention is not limited to the specific embodiments but various modifications, equivalents, and substitutions thereof fall within the scope of the present invention.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinbelow, the present invention will be described in greater detail with reference to the accompanying drawings. All terms or words used in the specification and claims should not be interpreted in an idealized or overly formal sense as defined in common dictionaries unless expressly so defined herein but should be interpreted as having meanings that are consistent with their meanings in the context of the relevant art. Unless otherwise defined, all terms including technical and scientific terms used herein have the same meanings as commonly understood by those skilled in the art to which the invention belongs. Herein below, in the description and drawings, details of well-known functions and configurations may be omitted to avoid unnecessarily obscuring the gist of the present invention. The drawings provided herein are for illustrative purposes and for good delivery of the spirit of the present invention. In addition, the present invention is not limited to the accompanying drawings but may be embodied in different forms. In addition, throughout the description of the present invention, like reference numerals may refer to like elements. Likewise, throughout the drawings, like elements are denoted by like reference numerals.

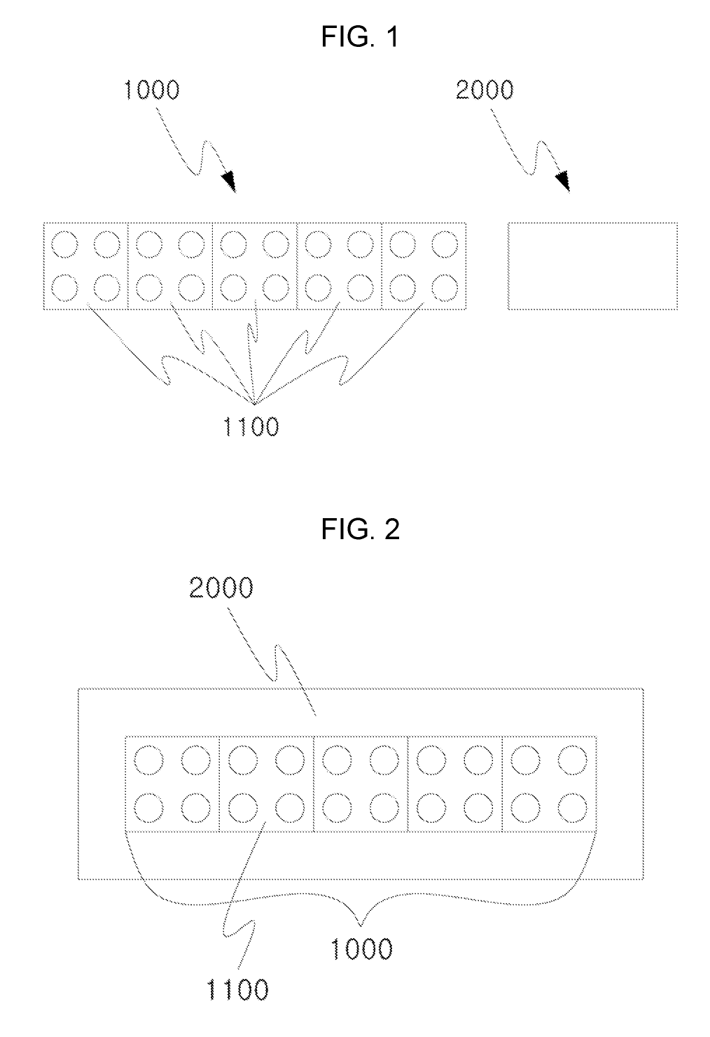

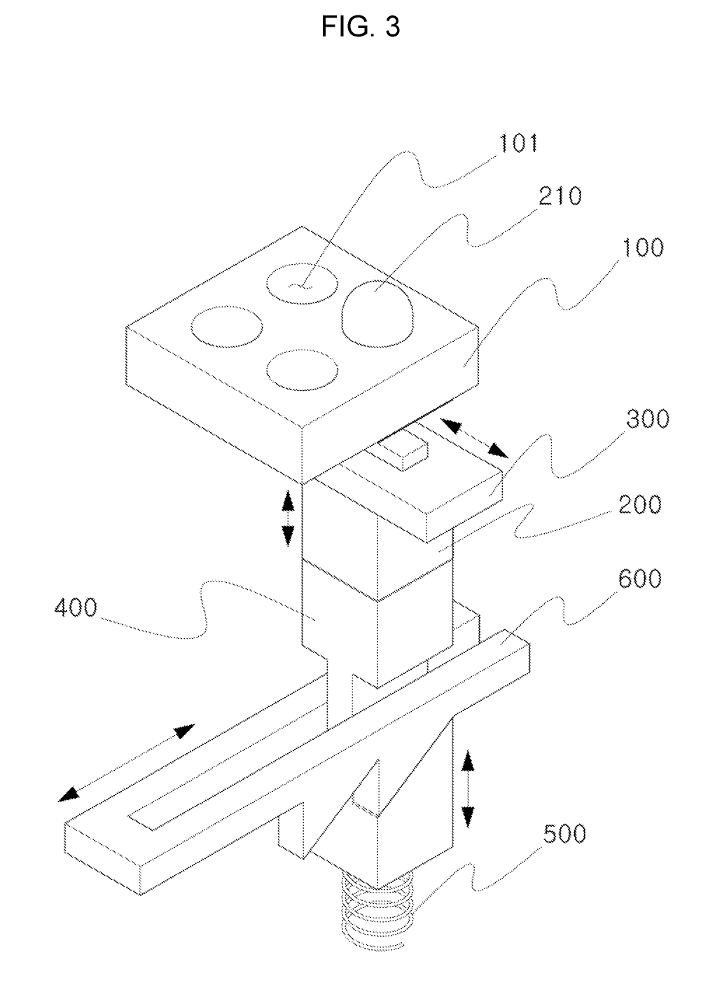

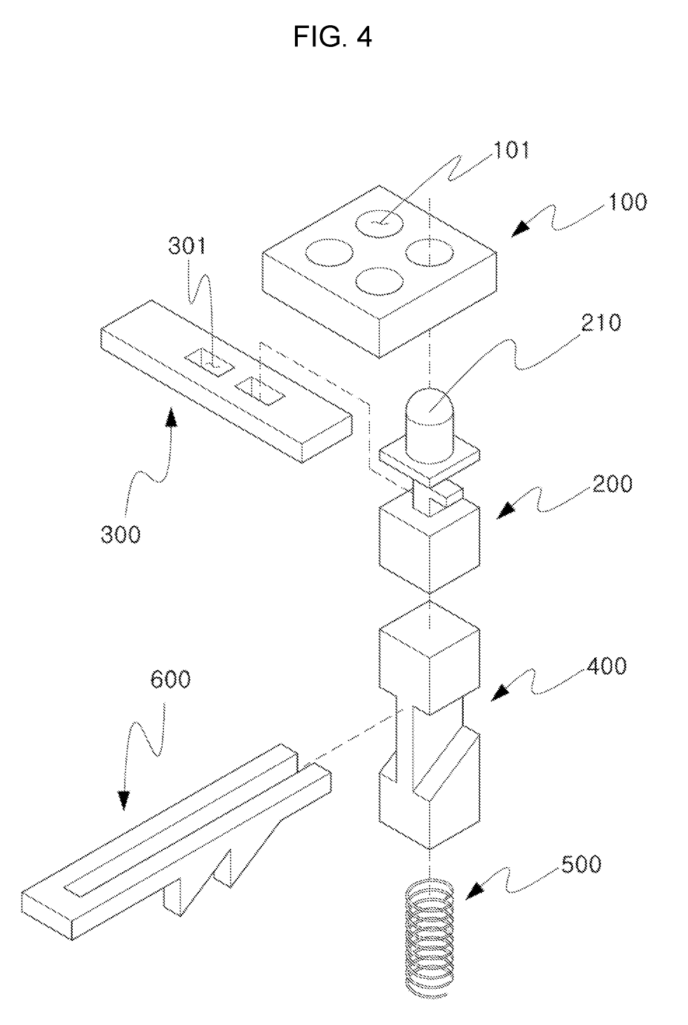

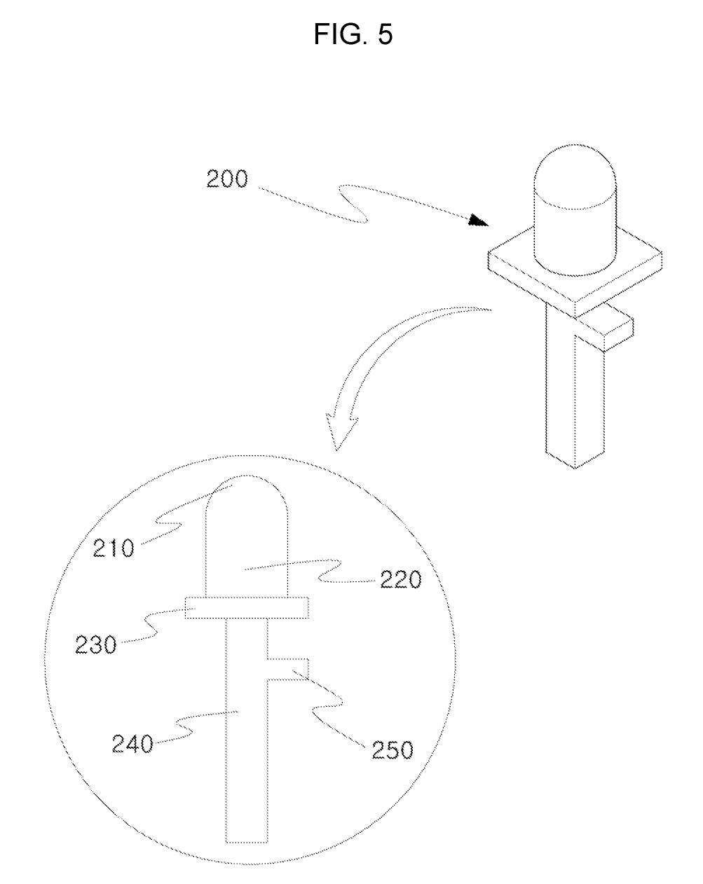

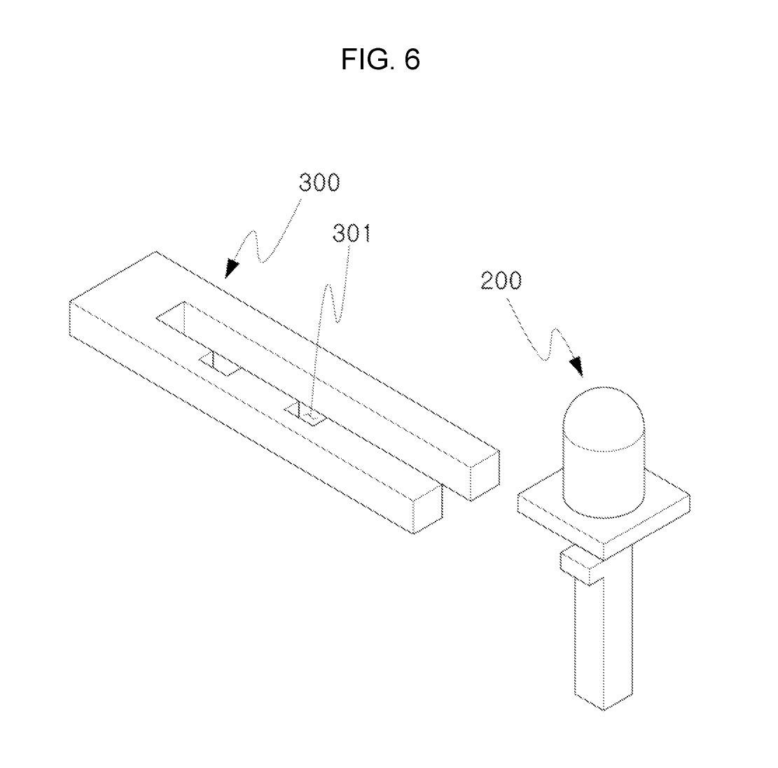

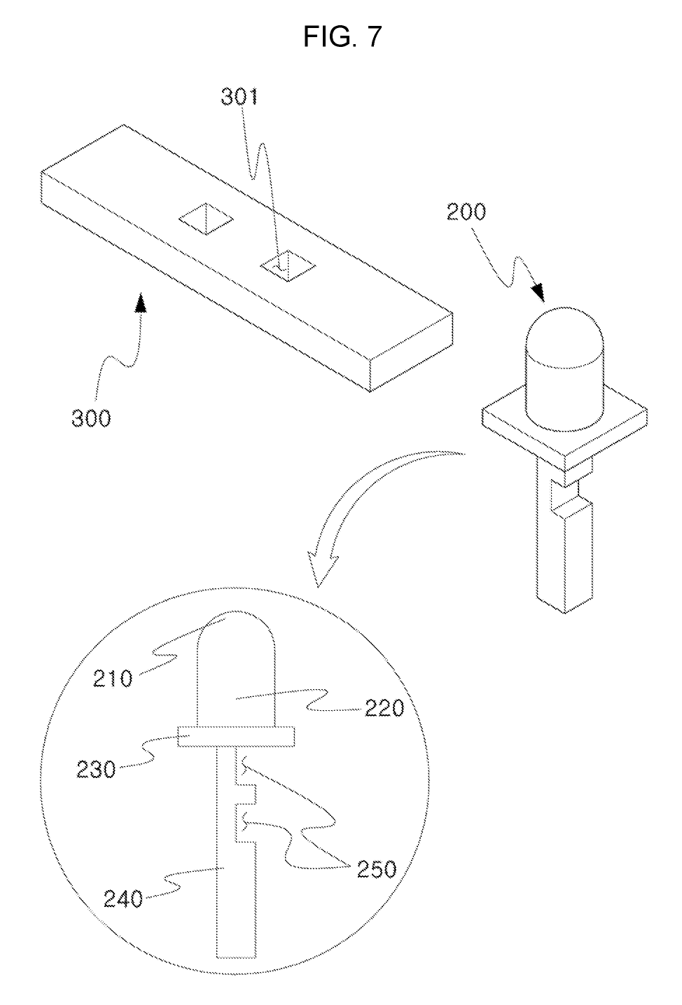

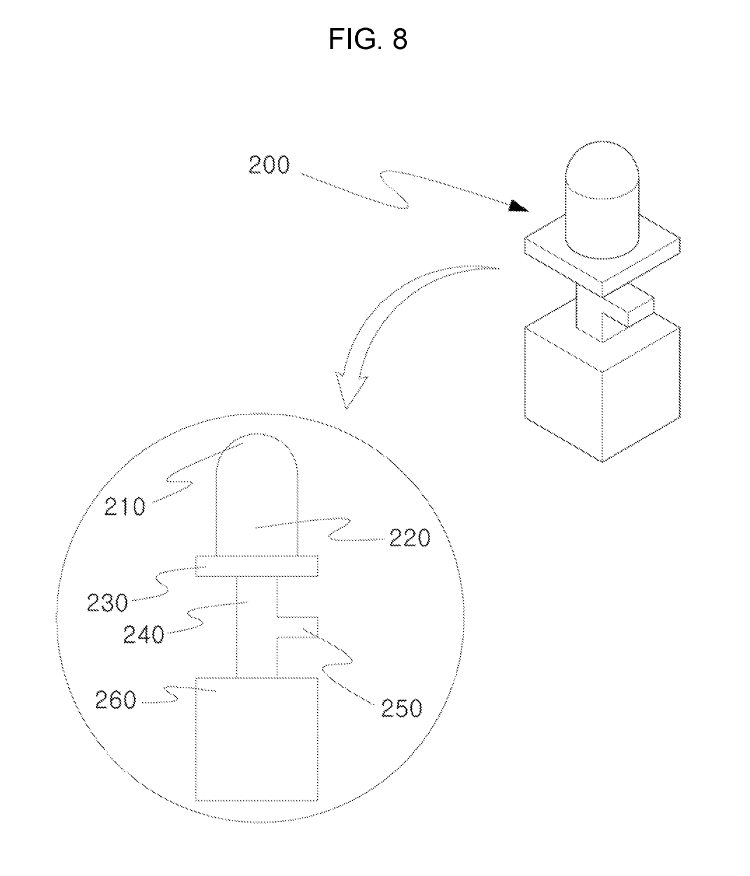

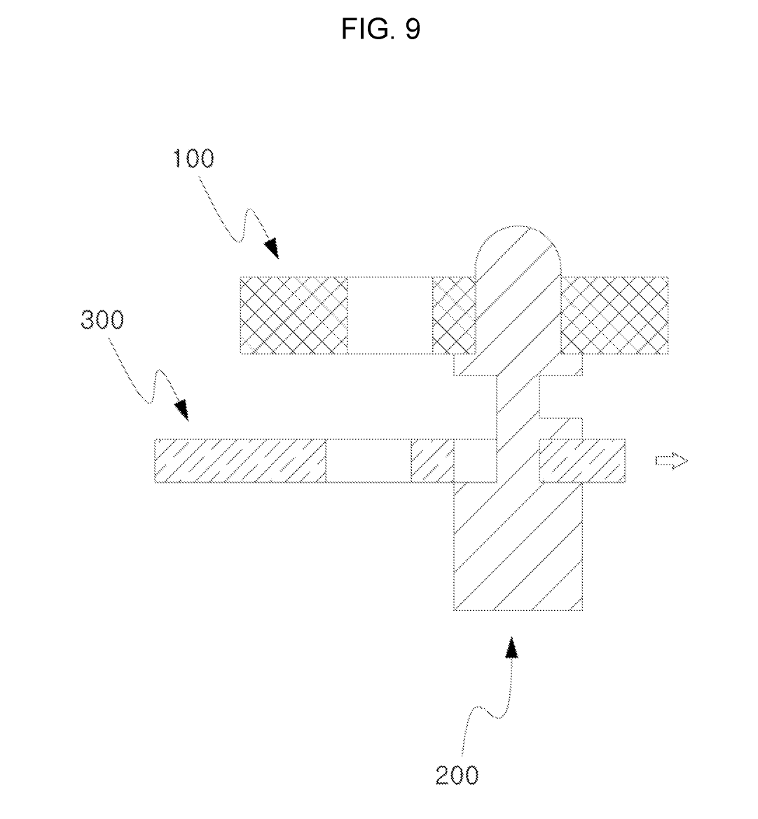

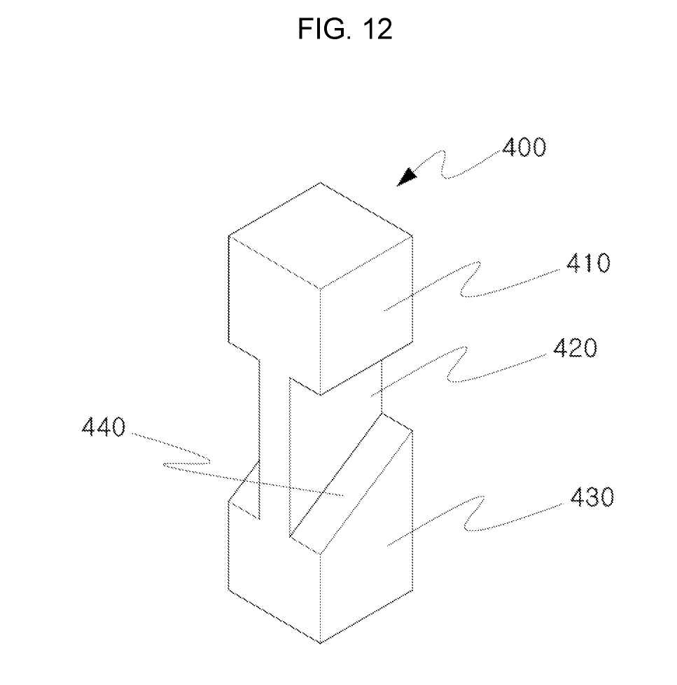

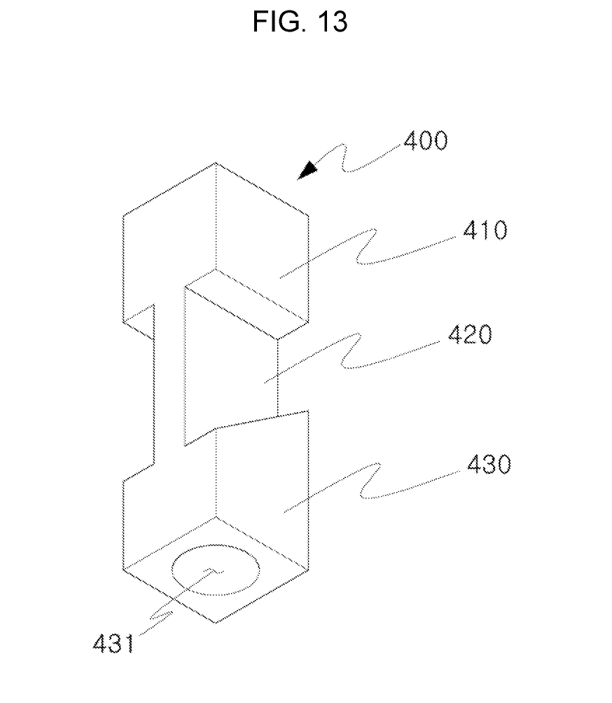

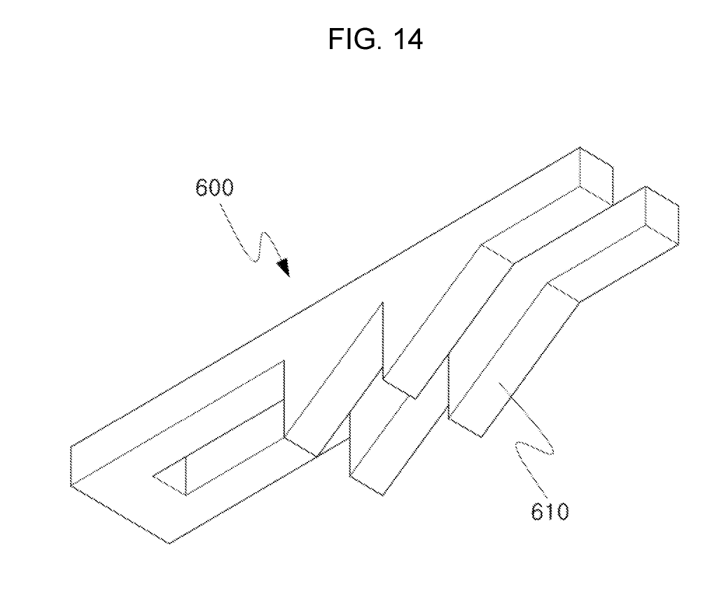

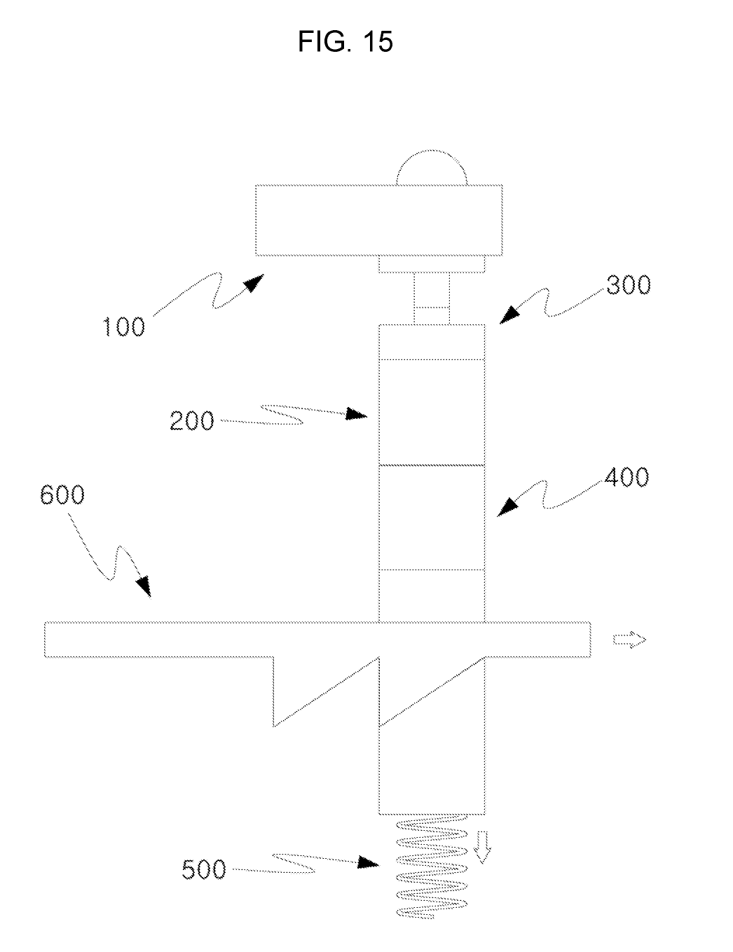

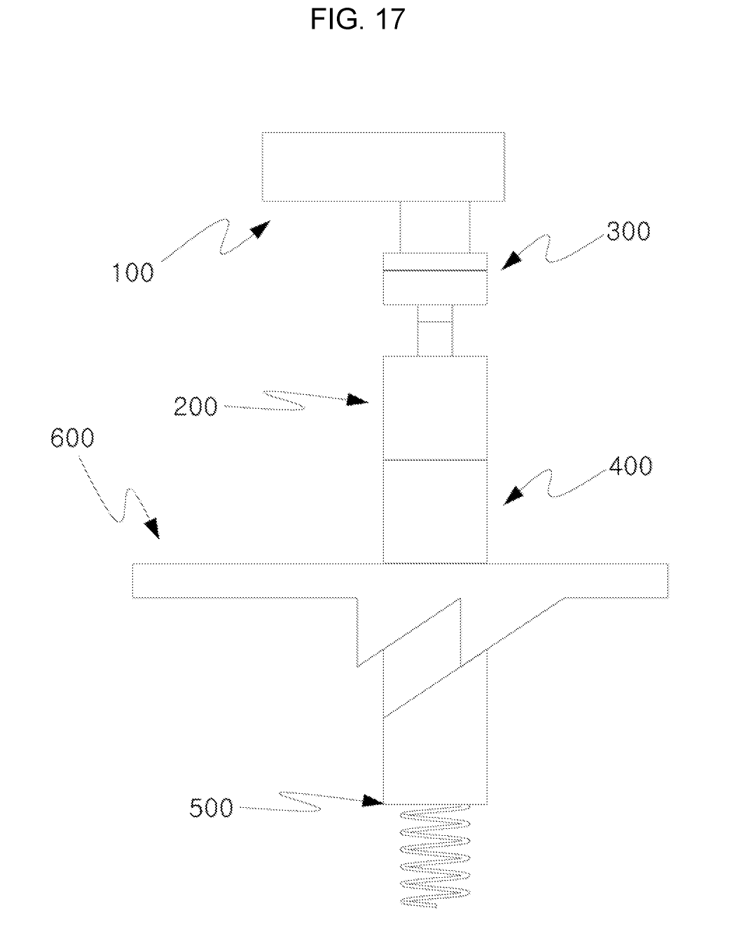

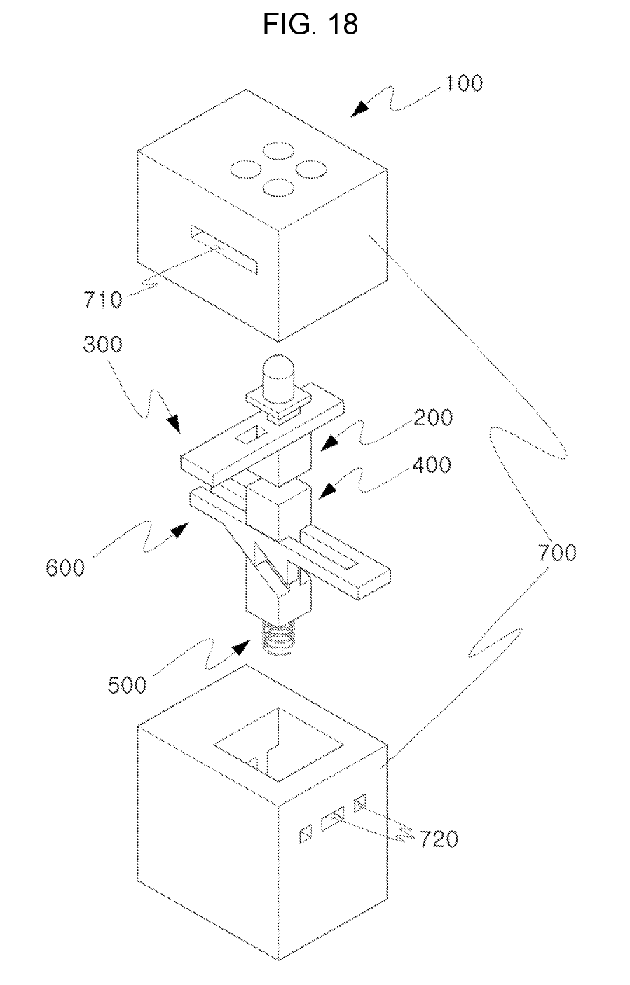

FIG. 1 is a plan view illustrating the concept of a button having variable Braille modules according to one embodiment of the present invention; FIG. 2 is a plan view illustrating the concept of a button having variable Braille modules according to another embodiment of the present invention; FIG. 3 is a perspective view illustrating an operational relationship among parts of the button having variable Braille modules according to one embodiment of the present invention; FIG. 4 is an exploded perspective view of FIG. 1; FIG. 5 is an exemplary view illustrating an example of an upper block of the button having variable Braille modules according to one embodiment of the present invention; FIG. 6 is an exemplary view illustrating an example of an upper block and an upper support block of the button having variable Braille modules according to one embodiment of the present invention; FIG. 7 is an exemplary view illustrating another example of the upper block and the upper support block of the button having variable Braille modules according to one embodiment of the present invention; FIG. 8 is an exemplary view illustrating the upper block of FIG. 1; FIGS. 9 to 11 are cross-sectional views illustrating an operational relationship between the upper block and the upper support block of FIG. 1; FIGS. 12 to 13 are perspective views illustrating a lower block of FIG. 1; FIG. 14 is a perspective view illustrating a lower adjustment unit of FIG. 1; FIGS. 15 to 17 are plan views illustrating an operational relationship of FIG. 1; and FIG. 18 is a partially cut-away exploded perspective view illustrating that the button having variable Braille modules according to one embodiment of the present invention includes a housing.

In the drawings that will be described below, although a display unit 100 is provided with four through holes 101, the present invention is not limited thereto but such an example is provided only to aid understanding of the present invention. In the drawings, only one upper block upper block 200, one upper support block 300, one lower block 400, and one elastic unit 500, and one lower adjustment unit 600 are illustrated for a convenient description although a plurality of each part may be provided.

When displaying information such as Braille words, figures, or images by moving a plurality of plungers up and down, the plungers are operated by row by row or column by column according to the present invention while the plungers are individually operated in conventional arts. For this reason, according to the present invention, it is possible to provide a button having variable Braille modules each composed of a reduced number of parts to be controlled, whereby the button has a simple structure and is conveniently controlled.

The button having variable Braille modules, according to one embodiment of the present invention, is to enable visually impaired people to use a KIOSK that is an unattended wireless terminal that is installed in government agencies or local government agencies, or public places such as banks, department stores, and exhibition centers. The KIOSK provides traffic information and public transportation information, route guide service, fare card distribution service, reservation service, telephone number and address information providing service, administrative procedures guide, products information, facilities guide, etc.

Referring to FIGS. 1 to 2, the button having variable Braille modules, according to one embodiment of the present invention, includes an information display unit 1000 and a button 2000.

The information display unit 1000 is provided with a plurality of variable Braille modules 1100 in which upper protrusions 210 move up to protrude from the top surface of the display unit row by row or column by column to display information.

That is, an array of the plurality of variable Braille modules 1100, each of which is composed of 2*2 dots (4 dots), 3*2 dots (6 dots), or 4*2 dots (8 dots) and represents a Braille letter, number, or punctuation mark, constitutes the information display unit 1000 for displaying various information. For example, one variable Braille module 1100 can construct one letter, number, or punctuation mark. When a plurality of variable Braille modules 1100 is combined, the information display unit 1000 that can display various information (for example, sentences) can be implemented.

When the button 2000 is pressed or touched, a command corresponding to the content displayed on the information display unit 1000 is input.

For example, when the word “withdrawal” is displayed on the information display unit 1000 and when the button 2000 is pressed or touched in that state, a menu item “withdrawal” is selected.

Although FIGS. 1 to 4 illustrate an example in which only one menu item is presented, the present invention is not limited thereto. There may be a plurality of information display units 1000 and a plurality of buttons 2000 so that a plurality of menu items including “deposit”, “withdrawal”, “bankbook updating”, etc. may be displayed simultaneously.

As illustrated in FIG. 1, the button 2000 is spaced from the variable Braille modules 1100 by a predetermined distance. When a pressing or touching operation is performed on the button 2000, a command is input.

Although FIG. 1 illustrates an example in which the button 2000 is arranged on the right side of the variable Braille modules 1100, the present invention is not limited thereto. The button 2000 can be arranged on any side among the upper side, lower side, left side, and the right side of the variable Braille modules 1100. Alternatively, as illustrated in FIG. 2, the button 2000 may be formed to surround the array of the variable Braille modules 1100.

In the case where the command is input through a pressing operation, a method in which the command input is made according to the contact or non-contact of a switch may be adopted.

In the case where the command is input through a touching operation, in order to prevent a mistaken input operation, the command input may be recognized through a double touching operation. Alternatively, when the button is touched the first time, the command to be performed is output via voice, and when the button is touched the second time, the command is then recognized.

The button 2000 may be integrated with the array of the variable Braille modules 1100. In this case, the command input can be performed through touching or pressing of the array of the variable Braille modules 1100.

That is, when the array of the variable Braille modules 1100 is touched or pressed, the command may be input.

When the command input is made through the pressing operation, a method in which the input is made according to the contact or the non-contact of a switch may be adopted.

When the command input is made through the touching operation, a touch operation or a double touching operation that is performed in several seconds after the user confirms the information represented by the Braille modules and then separates the Braille modules may be recognized as the command input operation. Alternatively, when the button integrated with the Braille modules is touched the first time, the command to be performed is output via voice, and when the button is touched the second time, the command is then recognized.

In the button having variable Braille modules illustrated in FIGS. 3 to 4, according to one embodiment of the present invention, the variable Braille module 1100 includes a display unit 100, an upper block 200, an upper support block 300, a lower block 400, an elastic unit 500, and a lower adjustment unit 600. The upper support block 300 may lock the upper blocks 200 in a row or column unit of the variable Braille modules 1100. The lower adjustment unit 600 restricts the heights of the variable Braille modules 1100 in a row or column unit such that the lower blocks 400 can move up to only a predetermined height limit.

That is, when the upper support block 300 locks the upper blocks 200 in a row unit, the lower adjustment unit 600 restricts the heights of the lower blocks 400 in a column unit.

Conversely, when the upper support block 300 locks the upper blocks 200 in a column unit, the lower adjustment unit 600 restricts the heights of the lower blocks 400 in a row unit.

The display unit 100 is provided with a plurality of through holes 101 arranged in a predetermined arrangement pattern.

In the display unit 100, the plurality of through holes 101 is arranged in a specific pattern so that the plurality of plungers selectively protrudes from the top surface of the display unit 100 through the plurality of through holes 101 to display information such as Braille words, diagrams, or images. For example, the plurality of through holes 101 may be arranged in 100 rows and 50 columns.

The upper block 200 is provided under the through hole 101 and moved up and down. When the upper block 200 is moved up, the upper protrusion 210 protrudes from the upper end of the through hole 101.

The upper protrusion 210 protrudes from the upper end of the through hole 101 or retreats into the through hole 101 according to the up and down movement of the upper block 200.

The upper support block 300 locks the upper block 200.

The upper support block 300 may lock the upper block 200 in a state in which the upper protrusion 210 of the upper block 200 protrudes from the upper end of the through hole 101 or in a state in which the upper protrusion 210 of the upper block 200 retreats into the through hole 101.

The lower blocks 400 are provided under the respective upper blocks 200, and are moved up and down. When the lower block 400 is moved up, the lower block 400 pushes the upper block 200 upward.

The lower block 400 pushes the upper block 200 upward, and the upper support block 300 pushes the upper block 200 that is in an unlocked state upward.

The elastic units 500 are provided under the respective lower blocks 40, and push the respective lower blocks 400 upward by using their elastic force.

The lower adjustment unit 600 has a function of restricting the upward movement of the lower block 400 such that the lower block 400 cannot move up to be higher than a predetermined height limit.

That is, when the lower adjustment unit 600 raises the lower block 400 up to the predetermined height, the lower block 400 is moved up by the elastic force of the elastic unit 500, thereby pushing the upper block 200 upward. At this time, the upper support block 300 pushes upward the upper block 200 that is not yet locked. Afterwards, the upper support block 300 locks the upper block 200.

Although FIGS. 1 to 4 illustrate an example in which a direction in which the upper support block 300 moves and a direction in which lower adjustment unit 600 moves are perpendicular to each other, the present invention is not limited thereto. The movement direction of the upper support block 300 and the movement direction of the lower adjust block 600 may by differently set when such settings satisfy the condition in which the upper support block 300 can lock the upper blocks 200 in a row or column unit and the lower adjustment unit 600 can restrict the heights of the lower blocks 400 in a column unit or in a row unit.

The button having variable Braille modules, according to one embodiment of the present invention, can be manually or automatically controlled.

Referring to FIGS. 5 to 7, according to one embodiment of the present invention, the upper block 200 of the button having variable Braille modules includes the upper protrusion 210, a movement shaft portion 220, an upper-end upward movement stopper 230, an upper pillar portion 240, and a engagement portion 250.

The movement shaft portion 220 extends downward from a lower end of the upper protrusion 210, has a shape corresponding to that of the through hole 101, and has a pillar shape having a smaller horizontal cross-sectional area than the through hole 101.

The movement shaft portion 220 performs up and down reciprocating motion in the through hole 101. In regards to the upward movement of the upper block 200, the upper block 200 moves by the pushing force of the lower block 400. However, in regards to the downward movement of the upper block 200, the upper block 200 moves by gravity. Therefore, it is preferable the movement shaft portion 220 has the shape corresponding to the shape of the through hole 101 and the horizontal cross-sectional area smaller than that of the through 101 so that the movement shaft portion 220 will not be stuck in the through hole 101 when it moves down by the gravity.

The upper-end upward movement stopper 230 extends in a horizontal direction from a lower end of the movement shaft portion 220 and has a horizontal cross-sectional area larger than that of the through hole 101.

The upper-end upward movement stopper 230 is disposed under the display unit 100, and prevents the upper block 200 from excessively protruding from the upper end of the through hole 101.

The upper pillar portion 240 extends downward from a lower end of the upper-end upward movement stopper 230 has a pillar shape having a horizontal cross-sectional area smaller than that of the upper-end upward movement stopper 230.

The upper pillar portion 240 is a member to move up and down the upper block 200. The upper pillar portion 240 is moved up and down in a state in which the upper pillar portion 240 is engaged with the upper support block 300.

The engagement portion 250 protrudes in a horizontal direction from a side surface of the upper pillar portion 240 (as illustrated in FIGS. 5 and 6) or is recessed in the horizontal direction from the side surface (as illustrated in FIG. 7).

The engagement portion 250 is a member to lock the upper block 200 by using the upper support block 300 that will be described below.

As illustrated in FIG. 8, the upper block 200 of the button having variable Braille modules, according to one embodiment of the present invention may further include a upper-end downward movement stopper 260 extending downward from a lower end of the upper pillar portion 240 and having a pillar shape having a horizontal cross-sectional area larger than that of the upper pillar portion 240.

The upper-end downward movement stopper 260 is blocked by the upper support block 300 that will be described below when it moves, thereby preventing the upper block 200 from excessively protruding from the upper end of the through hole 101. In this aspect, the upper-end downward movement stopper 260 has the same function as the upper-end upward movement stopper 230. However, the upper-end downward movement stopper 260 also has an additional function of not only preventing the upper-end upward movement stopper 230 from being damaged. Furthermore, the upper-end downward movement stopper 260 prevents the upper block 200 from excessively protruding from the upper end of the through hole 101 in the case where the upper-end upward movement stopper 230 is damaged.

It is preferable that the upper-end upward movement stopper 230 and the upper-end downward movement stopper 260 have an identical cross-sectional shape. This design is to facilitate the upward and downward movement of the upper block 200 in a housing having a cylinder-shaped internal structure.

As illustrated in FIGS. 4, 6, and 7, according to one embodiment of the present invention, the upper support block 300 of the button having variable Braille modules is assembled to move in a horizontal direction with respect to the upper pillar portion 240. In addition, the upper support block 300 is provided with a movement slot 301 within which the upper pillar portion 240 moves up and down.

The movement slot 301 may allow or may not allow the engagement portion 250 to pass therethrough in accordance with the movement of the upper support block 300.

For example, in FIG. 4, when the upper support block 300 is moved in the direction in which the engagement portion 250 protrudes, the up and down movement of the upper block 200 is allowed. Conversely, when the upper support block 300 is moved in the opposite direction, the upper block 200 is locked.

In FIG. 6, only when the position of the engagement portion 250 and the position of the movement slot 301 correspond to each other, the engagement portion 250 can move through the movement slot 301.

In FIG. 7, when the upper support block 300 is moved in a direction opposite to a direction in which the engagement portion 250 is recessed, the up and down movement of the upper block 200 is allowed. Conversely, when the upper support block 300 is moved in the direction in which the engagement portion 250 is recessed, the upper block 200 is locked.

The operation of the upper block 200 and the upper support block 300 of the button having variable Braille modules, according to one embodiment of the present invention, will be described with reference to FIGS. 9 to 11.

FIG. 9 is a cross-sectional view illustrating a state in which the upper block 200 is locked by the upper support block 300.

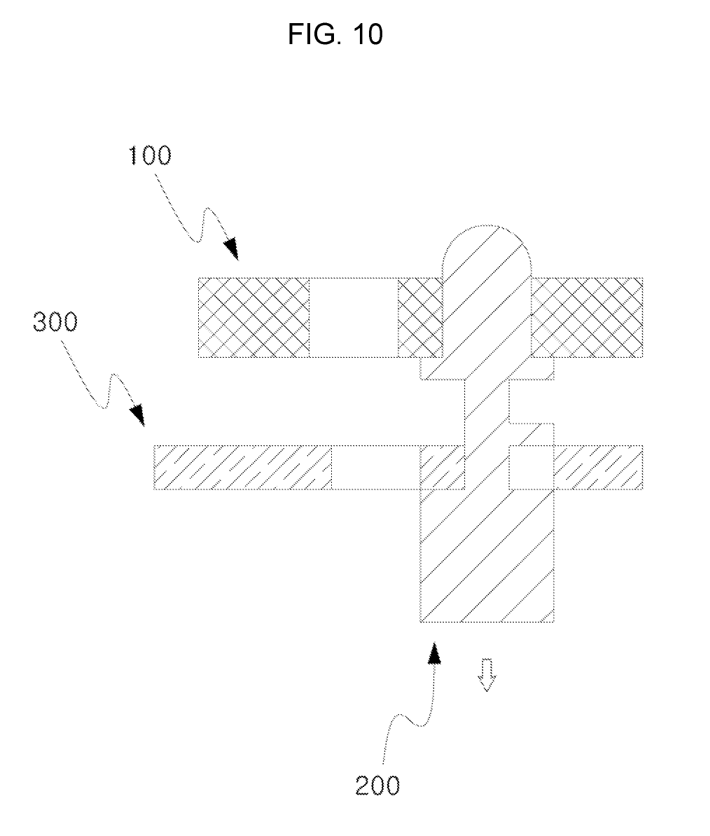

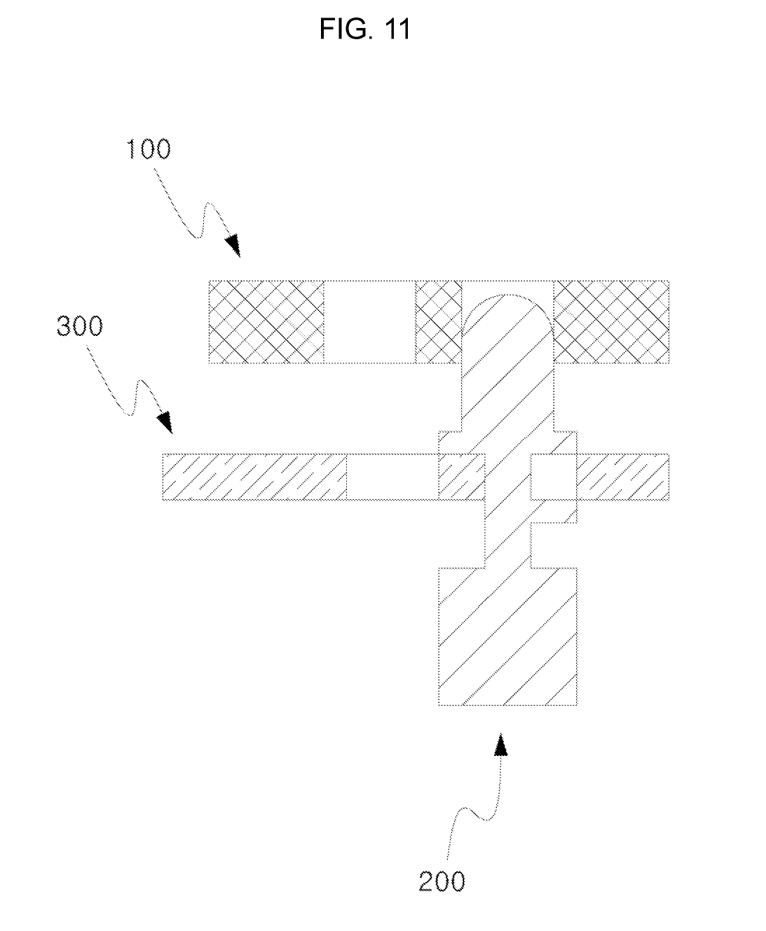

When the upper block 200 is pushed leftward in a manner illustrated in FIG. 10 from the state of FIG. 9, that is, when the upper block 200 becomes a state illustrated in FIG. 11, the upper block 200 moves down due to the gravity as illustrated in FIG. 11.

That is, when the upper block 200 is not locked by the upper support block 300, the upward movement of the upper block 200 is carried out by the pushing-up force of the lower block 400, and the downward movement of the upper block 200 is carried out by the gravity.

As illustrated in FIGS. 12 to 13, the lower block 400 of the button having variable Braille modules, according to one embodiment of the present invention, includes a lower-end upward movement stopper 410, a lower pillar portion 420, a lower-end downward movement stopper 430, and a first inclined portion 440.

The lower-end upward movement stopper 410 has a pillar shape.

The lower-end upward movement stopper 410 enables the lower block 400 to be blocked by the lower adjustment unit 600 when the lower block 400 moves down, thereby preventing the lower block 400 from excessively moving down.

The lower pillar portion 420 extends downward from a lower end of the lower-end upward movement stopper 410 and has a pillar shape having a horizontal cross-sectional area smaller than that of the lower-end upward movement stopper 410.

The lower pillar portion 420 is a member to move up and down the lower block 400, and is moved up and down in a state in which lower pillar portion 420 is fitted in a hole of the lower adjustment unit 600.

The lower-end downward movement stopper 430 extends downward from a lower end of the lower pillar portion 420 and has a pillar shape having a horizontal cross-sectional area larger than that of the lower pillar portion 420.

The lower-end downward movement stopper 430 is blocked by the lower adjustment unit 600 that will be described below, thereby preventing the lower block 400 from excessively moving up.

The first inclined portion 440 is provided at an upper end of the lower-end downward movement stopper 430 and is an inclined surface.

The first inclined portion 440 is structure to cause the lower block 400 to vertically move down. That is, when the lower adjustment unit 600 that will be described below horizontally moves, the lower block 400 moves in a vertical direction due to the inclined surface.

The lower-end upward movement stopper 410 and the lower-end downward movement stopper 430 may have an identical cross-sectional shape. This design is to facilitate up and down reciprocating motion of the lower block 400 in the housing which will be described below and which has a cylinder-shaped internal space.

AS illustrated in FIG. 14, the lower adjustment unit 600 of the button having variable Braille modules, according to one embodiment of the present invention, may further include a second inclined portion 610 that is assembled with the lower pillar portion 420 in a manner of horizontally moving with respect to the center of the lower pillar portion 420 and which has an inclined surface corresponding to the first inclined portion 440. The first inclined portion 440 and the second inclined portion 610 are in tight contact with each other while facing each other. When the lower adjustment unit 600 horizontally moves, the lower block 400 vertically moves down due to the first and second inclined portions.

The lower adjustment unit 600 is provided with the second inclined portion 610 having a shape corresponding to that of the first inclined portion 440. That is, the lower adjustment unit 600 is a member to cause the lower block 400 to move vertically when it moves horizontally. Referring to FIG. 14, the second inclined portion is formed to protrude. Alternatively, the second inclined portion may be formed to be recessed.

In more detail, the lower block 400 is always applied with the pushing-up elastic force of the elastic unit 500, so that the lower block 400 is raised to a position where it is blocked by the lower adjustment unit 600. Thus, the upward movement of the lower block 400 is restricted by the lower adjustment unit 600. At this time, the height of the lower block 400 can be adjusted by horizontally moving the lower adjustment unit 600.

As illustrated in FIG. 13, the lower-end downward movement stopper 430 of the button having variable Braille modules, according to one embodiment of the present invention, is provided with an elastic coupling portion 431 that may be a recess or a protrusion to be engaged with the elastic unit 500.

Although the elastic coupling portion 431 is illustrated as a recess in FIG. 13, the present invention is not limited thereto. The elastic coupling portion 431 may be provided as a protrusion so as to be fitted in the lower adjustment unit.

The operation of the button having variable Braille modules, according to one embodiment of the present invention, will be described below with reference to FIGS. 15 to 17.

FIG. 15 is a cross-sectional view illustrating a state in which the lower block 400 is pushed up by the elastic unit 500.

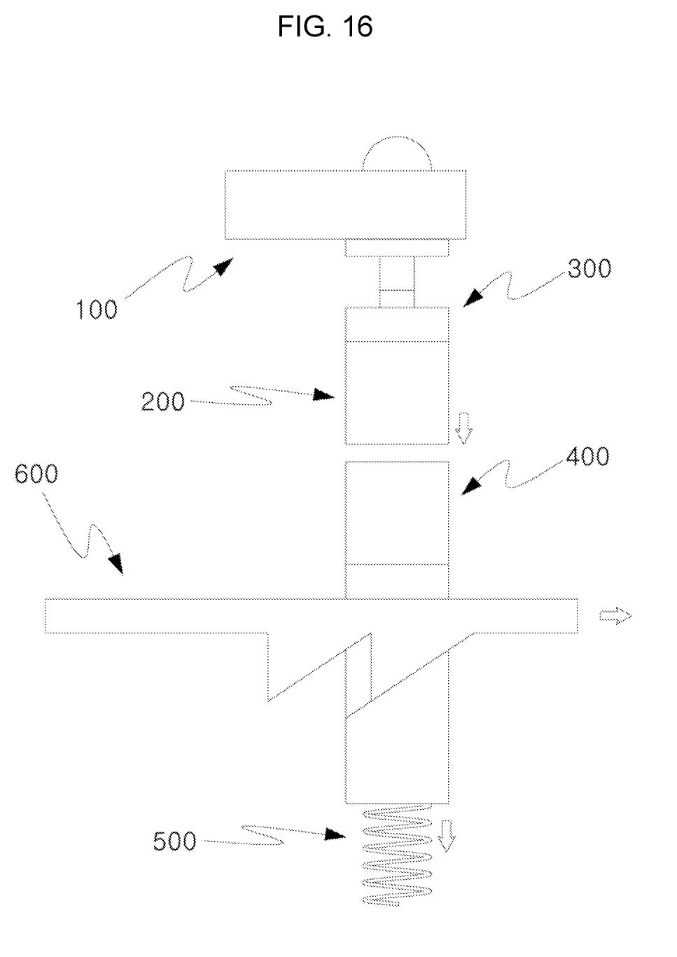

When the lower adjustment unit 600 in the state of FIG. 15 is pushed rightward in a manner illustrated in FIG. 16, that is, when the lower adjustment unit 700 changes to a state of 17, the upper block 200 moves down due to gravity as illustrated in FIG.

17.

That is, when the lower adjustment unit 600 pushes down the lower block 400 in a state in which the upper block 20 is not locked by the upper support block 300, the upper block 200 moves down due to gravity.

Based on this principle, the overall operation of the button having variable

Braille modules will be described below. Described is an example in which there is an array of 10*10 through holes 101 arranged in 10 rows and 10 columns 10, the lower adjustment unit 600 controls the lower blocks 400 column by column, and the upper support block 300 controls the upper blocks 200 row by row.

The lower adjustment unit 600 is operated such that the target upper protrusions in a first column are selectively operated to protrude, and then the upper support block 300 is operated such that the state of the protruding upper protrusions in the first column is locked. Next, the lower adjustment unit 600 is operated such that the target upper protrusions in a second column are operated to protrude, and then the upper support block 300 is operated to lock the protruding state of the upper protrusions in the second column.

Such an operation process is repeated until the target upper protrusions in a tenth column are operated to protrude and locked in the protruding state, whereby the display of information on the 10*10 through hole array is finished.

As described above, when displaying information with the 10*10 through hole array, only ten lower adjustment units 600 and only ten upper support blocks 300 are required. That is, it is possible to display information of 10 rows and 10 columns by operating a total of 20 parts.

As illustrated in FIG. 18, the button having variable Braille modules, according to one embodiment of the present invention, may further include a housing 700 that completely accommodates the upper block 200 and the lower block 400 and partially accommodates the upper support block 300 and the lower adjustment unit 600. That is, the upper support block 300 and the lower adjustment unit 600 are partially exposed outside the housing 700.

The housing 700 may be integrated with the display unit 100, or may be separated from the display unit 100 as necessary.

The housing 700 may be provided with an upper guide slot 710 through which the upper support block 300 horizontally moves and which maintains the height of the upper support block 300 and a lower guide slot 720 through which the lower adjustment unit 600 horizontally moves and which maintains the height of the lower adjustment unit 600.

It is preferable that the height of the upper support block 300 and the height of the lower adjustment unit 600 are constantly maintained. To this end, it is preferable that the housing is provided with the upper guide slot 710 for guiding horizontal movement of the upper support block 300 and the lower guide slot 720 for guiding horizontal movement of the lower adjustment unit 600.

The present invention is not limited to the above-described embodiments, has a large application range, and can be diversely embodied in various forms without departing from the gist of the present invention.

What is claimed is:

1. A button having variable Braille modules, the button comprising:
an information display unit (1000) including a plurality of variable Braille modules (1100) to display information, the variable Braille modules (1100) including a plurality of upper protrusions (210) arranged in rows and columns; and
a button (2000) configured to input a command corresponding to a content of the information displayed on the information display unit (1000) when the button (2000) is pressed or touched.

2. The button of claim 1, wherein each of the variable Braille modules (1100) includes:
a display unit (100) provided with a plurality of through holes (101) arranged in a predetermined pattern;
upper blocks (200) provided under the respective through holes (101) and configured to move up and down such that the upper protrusions (210) moves through the respective through holes (101) to selectively protrude from upper ends of the through holes (101) in accordance with upward and downward movement of the upper blocks (200);
an upper support block (300) configured to lock the upper block (200);
lower blocks (400) provided under the respective upper blocks (200) and configured to move up and down, the lower blocks (400) pushing up the respective upper blocks (400) when moving up;
elastic units (500) provided under the respective lower blocks (400) to apply pushing-up force to the lower blocks (400); and
a lower adjustment unit (600) configured to restrict upward movement of the lower blocks (400) to a predetermined height limit;
wherein the upper support block (300) locks the upper blocks (200) in a row or column unit of the variable Braille modules (1100), and
the lower adjustment unit (600) restricts upward movement of the lower blocks (400) in a row or column unit of the variable Braille modules 1100.

3. The button of claim 2, wherein each of the upper blocks (200) includes:
a movement shaft portion (220) extending downward from a lower end of the upper protrusion (210) and having a pillar shape corresponding to that of the through hole (101) and having a horizontal cross-sectional area smaller than that of the through hole (101);
an upper-end upward movement stopper (230) extending from a lower end of the movement shaft portion (220) and having a pillar shape having a horizontal cross-sectional area larger than that of the through hole (101);
an upper pillar portion (240) extending from a lower end of the upper-end upward movement stopper (230) and having a horizontal cross-sectional area smaller than that of the upper-end upward movement stopper (230); and
an engagement portion (250) being recessed or protruding in a horizontal direction from a side surface of the upper pillar portion (240).

4. The button of claim 3, wherein each of the upper blocks (200) further includes an upper-end downward movement stopper (260) extending from a lower end of the upper pillar portion (240) and having a pillar shape having a horizontal cross-sectional area larger than that of the upper pillar portion (240).

5. The button of claim 3, wherein the upper support block (300) is assembled with the upper pillar portion (240) in a manner of horizontally moving with respect to a center of the upper pillar portion (240), and
the upper support block (300) is provided with a movement slot (301) through which the upper pillar portion (240) moves.

6. The button of claim 2, wherein each of the lower blocks (400) includes:
a lower-end upward movement stopper (410);
a lower pillar portion (420) extending downward from a lower end of the lower-end upward movement stopper (410) and having a pillar shape having a horizontal cross-sectional area smaller than that of the lower-end upward movement stopper (410);
a lower-end downward movement stopper (430) extending downward from a lower end of the lower pillar portion (420) having a pillar shape having a horizontal cross-sectional area larger than that of the lower pillar portion (420); and
a first inclined portion (440) provided at an upper surface of the lower-end downward movement stopper (430) and configured as an inclined surface;
wherein the lower adjustment unit (600) is assembled with the lower pillar portion (420) in a manner of horizontally moving with respect to a center of the lower pillar portion (420) and is provided with a second inclined portion (610) having a shape corresponding to that of the first inclined portion (440); and
the first inclined portion (440) and the second inclined portion (610) are in tight contact with each other while facing each other, thereby causing the lower block (400) to move down when the lower adjustment unit (600) is horizontally moved.

7. The button of claim 6, wherein a lower end of the lower-end downward movement stopper (430) is provided with a recess-shaped or protrusion-shaped elastic coupling portion (431) to be engaged with the elastic unit (500).

8. The button of claim 2, further comprising a housing (700) in which the upper block (200) and the lower block (400) are completely accommodated and the upper support block (300) and the lower adjustment unit (600) are partially accommodated such that the upper support block (300) and the lower adjustment unit (600) are partially exposed outside the housing (700),
wherein the housing (700) is provided with an upper guide slot (710) through which the upper support block (300) horizontally moves and which maintains a horizontal height of the upper support block (300) and a lower guide slot (720) through which the lower adjustment unit (600) horizontally moves and which maintains a horizontal height of the lower adjustment unit (600).

9. The button of claim 1, wherein the button (2000) is spaced from the variable Braille modules (1100) by a predetermined distance and is configured to input a command when the button (2000) is touched or pressed.

10. The button of claim 1, wherein the button (2000) is integrated with the variable Braille modules 1100, so that the button (2000) inputs a command when the variable Braille modules (1100) are touched or pressed.
